(19) United States
(12) Patent Application Publication
(10) Pub. No.: US 2003/0120749 A1
(43) Pub. Date: Jun. 26, 2003

(54) Method and apparatus for obtaining internet content for a wireless device

(76) Inventor: Michael D. Kotzin, Buffalo Grove, IL (US)

Correspondence Address: MOTOROLA INC, 600 NORTH US HIGHWAY 45, LIBERTYVILLE, IL, 60048-5343, US

(21) Appl. No.: 10/037,015

(22) Filed: Dec. 21, 2001

(51) Int. Cl. H04B 7/216; G06F 15/16

(52) U.S. Cl. 709/218; 370/320

(57) ABSTRACT

A method and apparatus provides for obtaining content for a wireless device in a more efficient manner by associating a code (i.e., other than a URL) (118) with at least both a desired content server (210a), such as an Internet server, and with control description data (420) that defines at least when to start recording the desired content from the desired server. This may include, for example, record description data such as a start record time (408) and other information. A code server (104) that is accessible via, for example, the Internet by a plurality of wireless devices, stores the code (118) with the associated control description data (420) on a per user basis. The code server (104) provides the stored control description data (420) to a wireless device (202) to facilitate time-based retrieval of the desired content in response to the record start time data (408) included in the control description data (420) provided by the code server (104).

### FIELD OF THE INVENTION

The invention relates generally to wireless communication systems and more particularly to obtaining and capturing content from a network such as the Internet or an intranet.

### BACKGROUND OF THE INVENTION

The Internet offers a large amount of information to be captured such as audio, video or other information content. However, with so much information to be potentially obtained, it becomes quite difficult to have an automated detection and capture system that is manageable for a user.

For example, some software applications provide hot keys or bookmarks that a user may create, such as a list of URLs that are saved on a computer or portable wireless device such as a telephone, PDA or other intranet appliance. However, such links are typically not portable and are stored locally by a Web browser. Other information identification or linking systems allow, for example, a user to customize a user's personalized home page to identify suitable links that can be accessed upon activation by the user. However, typically such page customization techniques do not provide the ability of a user to customize the functions that can be carried out by the interface.

As video content becomes more readily available via the Internet or other suitable networks, it would be desirable to provide a method and apparatus to simplify the selection and arranging of information that is captured from the Internet.

In addition, many of the URLs and other identifying information associated with given locations or addresses of video content or other information may be long in nature and difficult to remember.

In an unrelated field, a VCR+ recorder assigns a number, such as an index, to map a record time and an associated television channel or cable channel. The index is used by, for example, a VCR to record the program when the internal clock on the VCR matches the time embedded with the index map. This is a program recording mechanism that is not a network-based system and typically does not allow any users to select other functions other than recording by the VCR.

Accordingly, a need exists for a method and apparatus to simplify the selection and arranging of information to allow capture of content from the Internet or other suitable network by one or more of a plurality of wireless devices.

### BRIEF DESCRIPTION OF THE DRAWINGS

The present invention is illustrated by way of example and not limitation in the accompanying figures, in which like references indicate similar elements, and in which:

FIG. 1 is a block diagram illustrating one example of a system in accordance with one embodiment of the invention.

FIG. 2 is a block diagram of a wireless system in accordance with one embodiment of the invention.

FIG. 3 is a flow chart illustrating one example of a method for obtaining content for a wireless device in accordance with one embodiment of the invention.

FIG. 4 is a diagram illustrating a graphic user interface in accordance with one embodiment of the invention.

FIG. 5 is a flow chart illustrating an alternative embodiment of the present invention.

FIG. 6 is a diagram illustrating a code server database in accordance with one embodiment of the invention.

### DETAILED DESCRIPTION OF A PREFERRED EMBODIMENT

Briefly, a method and apparatus provides for obtaining content for a wireless device in a more efficient manner. The method and apparatus associates a code (preferably other than a URL) with at least both a desired server, such as an Internet server or destination URL, that contains the desired content. A code (e.g., index) is associated with the desired server and with control description data that defines at least when to start recording the desired content from the desired server. This may include, for example, record description data such as a start record time and other information. The method and apparatus also utilizes a code server that is accessible via, for example, the Internet or other network, that stores the code with the associated control description data. The code server provides the stored control description data to the wireless device to facilitate acquisition of the Internet content by the wireless device based on the code. The wireless device performs, for example, time-based retrieval of the desired content in response to the record start time data included in the control description data provided by the code server.

In one embodiment, the code server receives codes from a plurality of subscriber wireless devices and stores the code with associated control description data by generating a server code database containing a plurality of codes, each having associated control description data. If desired, the code server publishes an online directory accessible by the plurality of subscriber wireless devices wherein the directory includes each of the plurality of codes and a description of what the code does. In addition, the wireless device, transparent to the user of the wireless device, provides an access request to the code server and the wireless device obtains the desired content using the control description data sent back by the code server.

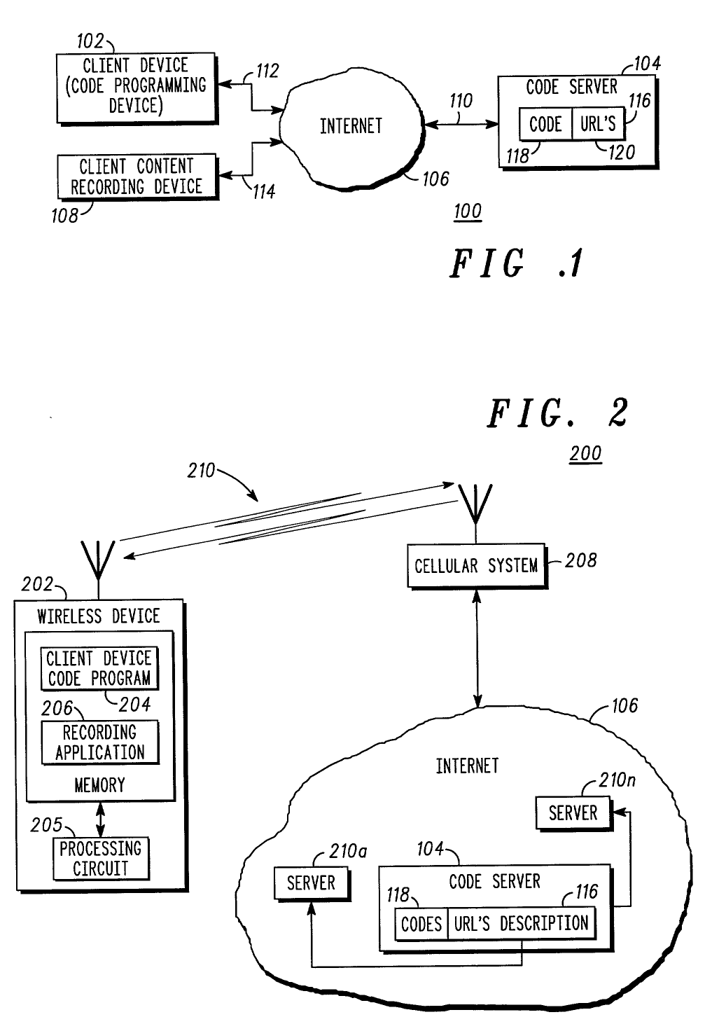

FIG. 1 illustrates one example of communication system 100 in accordance with one embodiment of the invention. The communication system 100 includes one or more client devices 102, a code server 104 and a network 106 such as the Internet, intranet or any other suitable network. In addition, the communication system 100 may include a client content recording device 108 associated with the client device 102. The client device 102 and client content recording device 108 may be included in the same device. For example, if the client device is an Internet appliance, the client content recording device may be a software or hardware video or audio recording circuit with associated memory as required. The client device 102 serves as the code programming device and as such has a suitable software algorithm executable from memory by one or more processing circuits such as a digital signal processor, a microcontroller, microcomputer, discrete logic, state machines, or any other suitable structure.

The code server 104 may be any suitable server that is in communication via suitable communication link 110 with the network 106. The client device 102 and client content recording device 108 are also in operative communication with the network 106 via suitable links 112 and 114, respectively. The code server, as further described below, includes a code server database 116 that includes, codes 118 and associated content source location data 120 such as destination addresses of desired servers within the network 106, such as URLs.

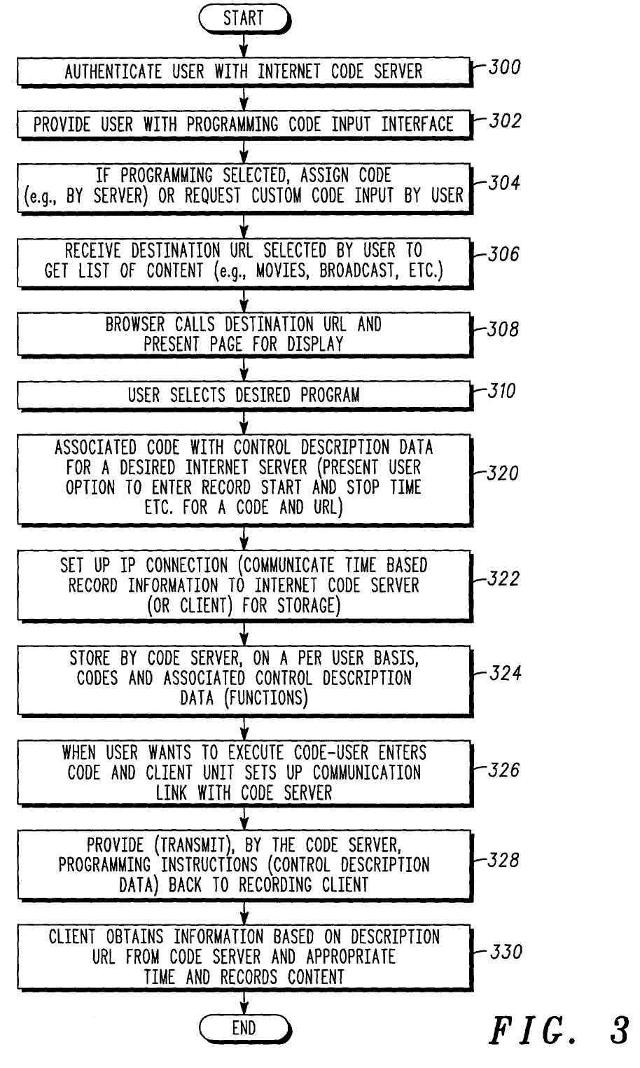

FIG. 2 illustrates a wireless communication system 200 that includes, for example, a wireless device 202 which serves as the client device 102 and also includes a client content recording device 108 in the form of a recording software application 206. The wireless device 202 includes a client device code program 204 (software application) and corresponding processing circuitry 205, such as, but not limited to, a DSP, microprocessor, microcomputer or any suitable processing devices to execute executable instructions. Alternatively, processing circuitry 205 may be discrete logic devices or other non-software based devices operable to carry out the operations described herein. The wireless device 202 is wirelessly coupled with a wireless system 208, such as a cellular system or other suitable wireless system, via a wireless link 210. The wireless system 208 is then operatively coupled with network 106 such as the Internet, or other suitable network. As shown, the code server 104 includes URLs or description information 116 associated with other servers 210a-210n located within the network 106.

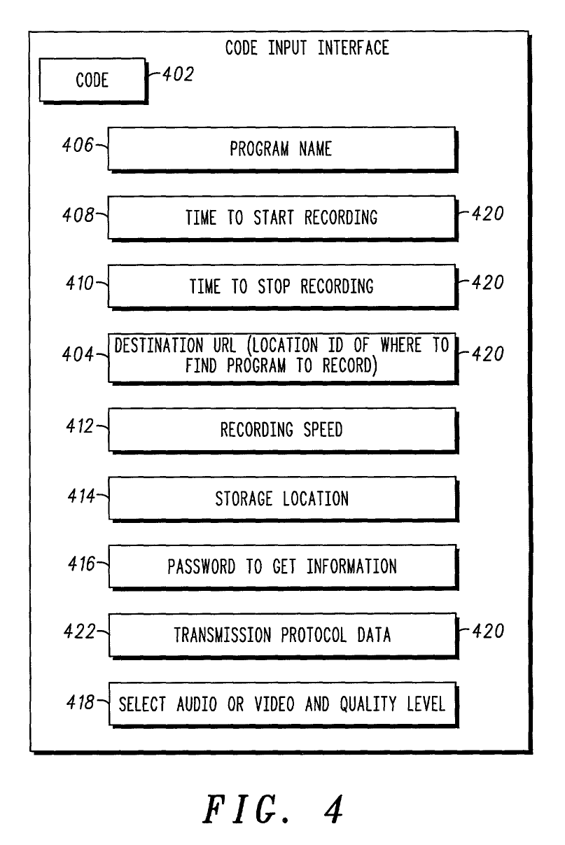

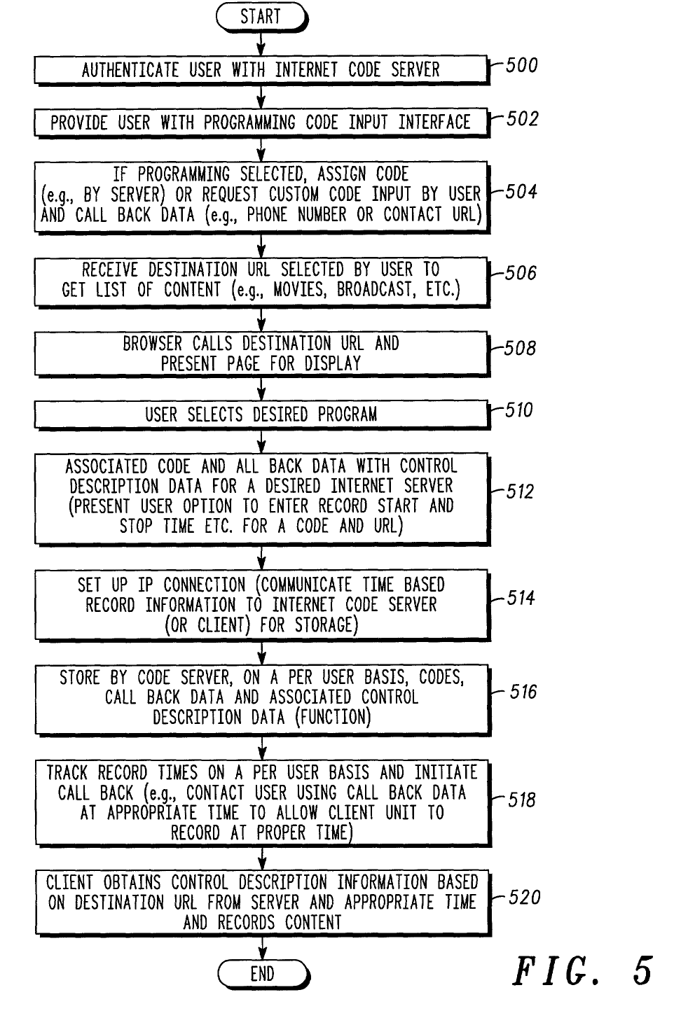

Referring to FIGS. 3 and 4, a method for obtaining content for a wireless device is shown that employs a time-based fetching operation by the wireless device and in particular, a Web browser within the client device. As shown in block 300, the method includes authenticating a user with the code server 104. For purposes of illustration, and not limitation, the invention will be described with reference to the Internet as the network. However, it will be recognized that any other suitable network may also be used. Authenticating the user with the code server 104 may be done in any conventional manner by, for example, exchanging passwords between the wireless device 102 and the code server to facilitate secure access to the code server. As shown in block 302, the method includes providing a user with a programming code input interface such as by the code program 204. One example of a programming code input interface 400 is shown in FIG. 4. The programming code input interface 400 allows a user to select whether or not the user wishes to create a new code for obtaining content from the Internet and to enter control description data 420. If the user selects to obtain a new code, the method includes, as shown in block 304, the code server 104 assigning a code 118, such as a 7-digit code, to the particular transaction the user wishes to set up. As an alternative, the programming code input interface 400 may also have a button or other suitable activation device to allow a user to customize his or her own code as opposed to having the code server assign a code.

As shown in block 306, once the code 118 has been assigned, the code server may send the code information to the wireless device so that the wireless device populates the code field 402 with the assigned code. The user selects or otherwise enters the source location data 120, such as a destination server address, or URL, for the server that contains desired content. By way of example, the user may enter the destination URL in the desired server field 404. As shown in block 308, in response to entering the destination URL in the desired server field 404, the client device code program 204, calls the Web browser to call the destination URL which in turn presents the associated home page for display to the user. As shown in block 310, the user may select the desired audio or video program to be recorded from the home page. To select the desired program, the user may enter the program name into the program designation field 406 or may, if desired, for example, double click on a particular movie title or audio title which then causes the home page application to automatically send the program name information to the programming code input interface for automatic population of the program designation field 406. In a similar way, the remaining fields of the programming code input interface 400 may also be populated either by manual entry by the user or by a click and reply scheme. Accordingly, the time to start the recording field 408 may be populated, the time to stop recording field 410 will be populated, the recording speed field 412 will be populated, and a storage location field 414, indicating, for example, where to store any recorded program will be populated. In addition, other fields such as a field identifying the passwords necessary to gain access to the content may also be populated, such as password field 416. In addition, an audio or video quality level field 418 may also be populated indicating a user selected video or audio quality level. It will be recognized that any other suitable fields may also be utilized if desired. Once the programming code input interface 400 has been populated, the fields other than the code field 402 serve as control description data 420 for a desired Internet server. The control description data 420 helps to define the functions that the user selected that are to be carried out upon capture of the information content. In this example, the function of the password is going to be necessary to allow access to the particular capture of the content located at the destination address indicated by desired server field 404. Accordingly, the client code program 204 which provides the programming code input interface 400 operates as a type of database data provider for the code server. It will be recognized that the code server 104 may also provide the association of the code 402 with the control description data 420 if the code description data 420 is sent to the code server. Preferably, the client device does not store the code information and associated control description data 420 to avoid unnecessarily large storage of information. The association of the code 118 is done by the code server which associates the code 402 with the control description data 420 for a desired Internet server as shown in block 320.

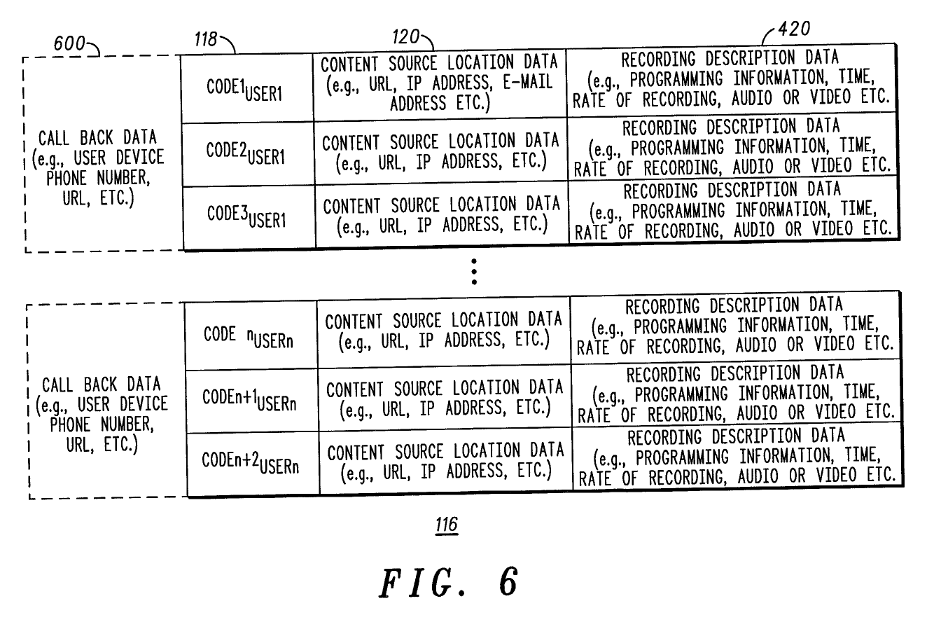

As shown in block 322, the method includes setting up an EP connection between the wireless device and the Internet code server 104 after the programming code input interface fields have been suitably populated. The Internet code server stores the code 118 with the associated control description data 420 in a code server database on a per user basis so that each user may have a plurality of different codes associated therewith and different control description data associated with each of the requisite codes. (See, for example, FIG. 6). This is shown in block 324. Accordingly, the wireless device sends the control description data 420 and associated code 118 so that the code server may maintain a central database of codes for a plurality of wireless devices and associated users that subscribe to the service provided by the code server.

As shown in block 326, when a user wishes to execute a code or carry out a transaction identified by a particular code, a user enters the code 118 into an interface provided by the client code program 204 and the client device sets up a communication link with the code server 104. As shown in block 328, the code server 104 provides, or transmits, the control description data 420 back to the wireless device so that the wireless device can carry out the recording of the content. Accordingly, the code server 104 provides the stored control description data back to the wireless device in response to receiving the code from the wireless device. In this example, where the recording time is provided as control description data back to the wireless device, the wireless device under the control the client control program waits for the appropriate recording time to contact the destination URL identified in the control description data 420 so that the wireless device provides time-based retrieval of the desired content in response to the record start time data included in the control description data 420.

In addition, as shown in step 324 above, the code server 104 generates the server code database containing a plurality of codes each having associated control description data and if desired publishes the codes in an on-line directory accessible by a plurality of subscriber wireless devices wherein the on-line directory includes each of the plurality of codes and a description of what the code does. For example, a code designated M0001 may be presented in an on-line directory with a description that it records a movie having a given title as obtained from the program name field 406. In this way, an on-line directory may be accessed by a plurality of wireless devices that subscribe to the service so that a user need not remember all the codes but may search, for example, by a user name code or other data to obtain the codes desired.

FIG. 5 illustrates a method for obtaining content for a wireless device wherein the code server 104 stores user call back data 600 with associated codes for a given user and initiates a call back to the wireless device in response to control description data associated with the particular code. Accordingly, a wireless device may transparently begin recording a program or otherwise obtain content from the Internet based on a call back or a call or other communication from the code server. The call back data may include, for example, a telephone number associated with the wireless device, an e-mail address or any other suitable call back data. Blocks 500-502 are the same as blocks 300-302 in FIG. 3. As shown in block 504, after the code program 204 is presented to the user, if programming is selected, in addition to selecting the control description data 420 described previously with respect to FIG. 3, the method includes providing call back data, such as a phone number or contact URL, as part of the information sent back to the code server and associated with a given code or group of codes. Accordingly, a user may have a phone number associated with the wireless device and the user may have numerous codes for recording or obtaining different content from a plurality of different desired servers. As shown in block 506, the method includes receiving a destination URL selected by a user to get a list of content to continue filling in the control description data. Accordingly, blocks 506-510 are the same as blocks 308-310.

As shown in block 512, another piece of data, namely the call back data 600 (see FIG. 6) is associated with the given code and the control description data. Block 514 is the same as block 322. As shown by block 516, the method includes, the code server storing on a per user basis, in addition to the code and associated control description data, the call back data 600.

Referring to FIG. 6, for example, the Internet code server database 116 is shown which includes the optional call back data 600. In this example, the same phone number is used by the code server to call back the wireless device anytime each of the codes 1, 2 or 3 for user 1 is desired. As shown, the code server database 116 contains the plurality of codes each having associated control description data 420.

As shown in block 518, the method includes, for example, the code server 104 tracking record times such as the data in the recording field 408 that has been stored by the code server 104, on a per user basis and compares the record time to an internal clock (not shown). Prior to the record time, the code server 104 initiates a call back in response to the control description data 420, namely in this example, the time record start time data that is associated with a particular code. The call back initiation may be done, for example, by contacting the cellular network based on the call back data, namely the telephone number. Once the communication is established, the code server 104 sends notification to the wireless device 202 with the appropriate control description data as to when to record, what the destination URL is, and other pertinent control description data. The wireless device 202 then transparent to the user, or based on user acceptance if desired, begins to obtain the content based on the control description data 420 which is shown, for example, in block 520.

The control description data 420 in one example, includes a destination identifier 404 field for desired content source, a record start time 408 field, a record stop time 410 field and transmission protocol data 422 field which indicates the required protocol necessary to retrieve the desired content from the desired content source.

The server and wireless devices contain processing circuits as noted above and associated memory that contain programming instructions that when executed by one or more processing circuits causes the one or more processing circuits to carry out the above operations. It will be recognized that the terms “processing circuit” in combination with associated “memory,” also includes discrete circuitry, state machines, firmware, or any suitable combination or hardware, software and firmware necessary to carry out the aforedescribed operations. The memory may be any suitable memory including, but not limited to, ROM, RAM, CD ROM, distributed memory, or any other suitable memory.

Accordingly, a mechanism is provided to reduce a complicated process and associated information and parameters into a very simple code, such as a numeric code that a user simply enters into the wireless device to effect the desired operation. The code uniquely identifies the information to be obtained from an Internet server or other suitable server and any other information as needed. The information may include when the information will be available (record time), the format and protocol of the transmission required, or any other suitable data. For example, when an entity has information that it wants to make available to wireless subscriber devices, the entity requests from the code server, for example, a seven-digit code. In exchange for the code, the entity provides all of the necessary information such as the access URL, time of video broadcast, transmission protocol and other information needed for a wireless device to capture or download the information. The code is published in the directory that tells a person what the code does. The user of the wireless device, if the user wants the information after reviewing the directory, either enters the seven-digit code into the wireless device or the wireless device may obtain the information transparently based on a time of day or other suitable event.

Accordingly, if a live video broadcast is going to be provided over the Internet, a user may enter a code that was received from a code server database wherein the code indicates the time of the day when the live video broadcast will be made. The wireless device may then automatically record the content of the video broadcast at the appropriate time without the user's knowledge based on the record time associated with the code. It will be recognized that the control description data may represent that the recording time is immediate such as when the code server pushes content to the wireless device.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for obtaining content for a wireless device comprising:
associating a code with at least both a desired server containing desired content and with control description data that defines at least when to start recording the desired content from the desired server;
storing in a code server, the code with associated control description data; and
providing, by the code server, at least the stored control description data to the wireless device to facilitate acquisition of content.

2. The method of claim 1 wherein the step of providing at least the stored control description data includes the step of performing, by the wireless device, time based retrieval of the desired content in response to record start time data included in the control description data.

3. The method of claim 1 including the step of, from time to time, sending the code by the wireless device to the code server; and in response to receiving the code, the code server performs the step of providing the stored control description data to the wireless device.

4. The method of claim 1 wherein the step of storing the code with the associated control description data includes generating a server code database containing a plurality of codes each having associated control description data and publishing an online directory accessible by a plurality of subscriber wireless devices wherein the directory includes each of the plurality of codes and a description of what the code does.

5. The method of claim 3 wherein the step of providing the code is done in response to an access request by the wireless device and transparent to a user of the wireless device, obtaining, by the wireless device the desired content using the control description data.

6. The method of claim 1 wherein the control description data includes at least one of: a destination identifier for a desired content source, a record start time for the content, a record stop time for the content, and transmission protocol required to retrieve the desired content from the desired content source.

7. The method of claim 1 including storing user call back data with associated codes for each of a plurality of users and initiating a call back in response to control description data associated with the code.

8. A method for obtaining content for a wireless device comprising:
associating a code with at least both a desired internet server containing desired content and with control description data that defines at least when to start recording the desired content from the desired internet server;
storing in a code server accessible via the internet, the code with associated control description data; and
providing, by the code server, at least the stored control description data to the wireless device to facilitate acquisition of internet content.

9. The method of claim 8 wherein the step of providing at least the stored control description data includes the step of performing, by the wireless device, time based retrieval of the desired content in response to record start time data included in the stored control description data.

10. The method of claim 9 including the step of, from time to time, sending the code by the wireless device to the code server; and in response to receiving the code, the code server performs the step of providing the stored control description data to the wireless device.

11. The method of claim 10 wherein the step of storing the code with the associated control description data includes generating a server code database containing a plurality of codes each having associated control description data and publishing an online directory accessible by a plurality of subscriber wireless devices wherein the directory includes each of the plurality of codes and a description of what the code does.

12. A wireless device comprising:
a processing circuit; and
memory containing programming instructions that when executed by one or more processing circuits causes the one or more processing circuits to:
provide a code to a code server wherein the code server contains a copy of the code and to provide control description data that defines at least when to start recording desired content from a desired internet server identified by the control description data; and
receiving stored control description data by the wireless device to facilitate acquisition of internet content.

13. The wireless device of claim 12 wherein the memory contains programming instructions that when executed by one or more processing circuits causes the one or more processing circuits to perform time based retrieval of the desired content in response to record start time data included in the stored control description data.

14. The wireless device of claim 12 wherein the control description data includes at least one of: a destination identifier for a desired content source, a record start time for the content, a record stop time for the content, and transmission protocol required to retrieve the desired content from the desired content source.

15. A server comprising:
a processing circuit; and
memory containing programming instructions that when executed by one or more processing circuits causes one or more processing circuits to:
associate a code with at least both a desired server containing desired content and with control description data that defines at least when to start recording the desired content from the desired server;
storing for the server, the code with associated control description data; and
providing, by the server, at least the stored control description data to a wireless device to facilitate acquisition of content by the wireless device.

16. The server of claim 15 wherein the memory contains programming instructions that when executed by one or more processing circuits causes the one or more processing circuits to, in response to receiving the code, performing the step of providing the stored control description data to the wireless device.

17. The server of claim 15 wherein the memory contains programming instructions that when executed by one or more processing circuits causes the one or more processing circuits to store the code with the associated control description data by generating a server code database containing a plurality of codes each having associated control description data and publishing an online directory accessible by a plurality of subscriber wireless devices wherein the directory includes each of the plurality of codes and a description of what the code does.
